(19) United States
(12) Patent Application Publication
(10) Pub. No.: US 2008/0133599 A1
(43) Pub. Date: Jun. 5, 2008

(54) System and method for providing address-related location-based data

(75) Inventors: William K. Stewart, San Francisco, CA (US); Sachin S. Kansal, Sunnyvale, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 11/634,328

(22) Filed: Dec. 5, 2006

(51) Int. Cl. G06F 17/30

(52) U.S. Cl. 707/104.1

(57) ABSTRACT

A method of providing location-based data comprises providing text to be displayed on a display of an electronic device, identifying address data within the text, the address data being associated with an address, and providing the text on the display with a selectable link associated with the address.

### CROSS-REFERENCE TO RELATED PATENT APPLICATIONS

This Application is related to U.S. application Ser. No. ______, filed Dec. 5, 2006 (Attorney Docket No. 035451-0246), entitled “DEVICE FOR PROVIDING LOCATION-BASED DATA,” which is herein incorporated by reference in its entirety.

### BACKGROUND

The present invention relates generally to the field of location-based services, and more particularly, to providing address-related location-based services.

Electronic devices such as desktop or laptop computers may include applications that provide location-based data (e.g., driving directions, a specific street address location, etc.) to a user based upon receiving, for example, a street address that is manually typed in by the user. These services, however, normally will require users to manually input the street address.

Further, while typical electronic devices often include a contacts application that may identify a street address for one or more of the contact listings, these devices do not permit users to quickly obtain location-based data directly from the contacts application.

Further yet, while electronic devices are able to display text, should a user wish to, for example, obtain location-based data regarding an address contained in the text, he or she must typically launch a separate location-based services application and manually enter the address.

Accordingly, there is a need for an electronic device that is able to provide location-based data and services directly from a contacts application. Further, there is a need for an electronic device that provides links to location-based data, the links being associated with addresses located in text.

The teachings herein extend to those embodiments which are within the scope of the appended claims, regardless of whether they accomplish one or more of the above-identified needs.

### BRIEF DESCRIPTION OF THE FIGURES

FIG. 1 is a front view of a mobile computing device according to an exemplary embodiment;

FIG. 2 is a back view of the mobile computing device of FIG. 1;

FIG. 3 is a block diagram of the mobile computing device of FIG. 1 according to an exemplary embodiment;

FIG. 4 is an image of information from a contacts database according to an exemplary embodiment;

FIG. 5 is an image of an email according to an exemplary embodiment;

FIG. 6 is an image of an email according to another exemplary embodiment;

FIG. 7 is an image for a location-based data application according to an exemplary embodiment;

FIG. 8 is an image of graphical location-based data according to an exemplary embodiment;

FIG. 9 is an image of graphical location-based data according to another exemplary embodiment;

FIG. 10 is an image of textual location-based data according to an exemplary embodiment;

FIG. 11 is a flowchart illustrating the process of providing location-based data according to an exemplary embodiment; and

FIG. 12 is a flowchart showing the process of providing location-based data according to another exemplary embodiment.

### DETAILED DESCRIPTION OF EXEMPLARY EMBODIMENTS

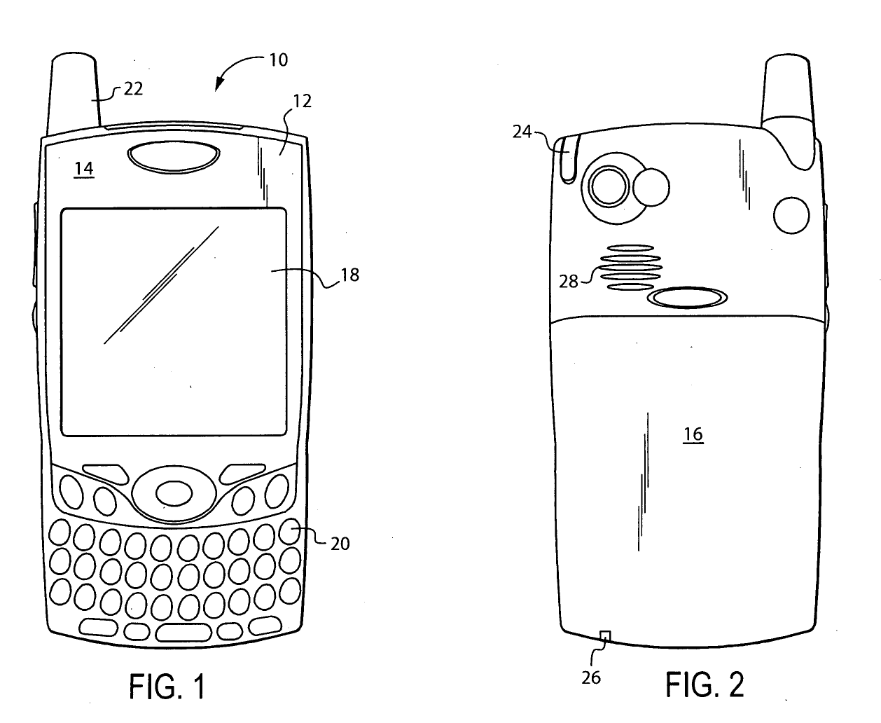

Referring to FIGS. 1 and 2, a mobile computing device 10 is shown. The teachings herein can be applied to device 10 or to other electronic devices (e.g., a desktop computer), mobile computing devices (e.g., a laptop computer) or handheld computing devices (e.g., a personal digital assistant (PDA), smartphone, etc.). According to one embodiment, device 10 is a smartphone, which is a combination mobile telephone and handheld computer having PDA functionality. PDA functionality can comprise one or more of personal information management, database functions, word processing, spreadsheets, voice memo recording, Global Positioning System (GPS) functionality, etc. Device 10 is configured to synchronize personal information from these applications with a computer (e.g., a desktop, laptop, server, etc.). Device 10 is further configured to receive and operate additional applications provided to device 10 after manufacture, e.g., via wired or wireless download, SecureDigital card, etc.

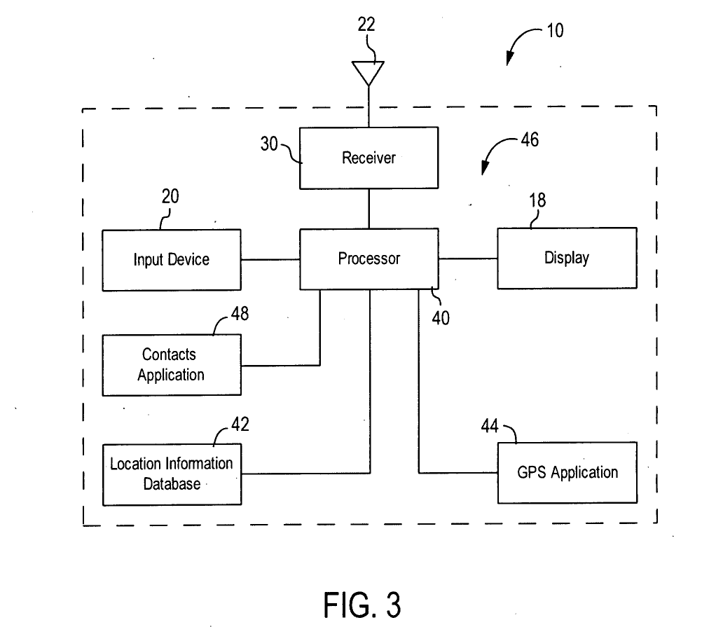

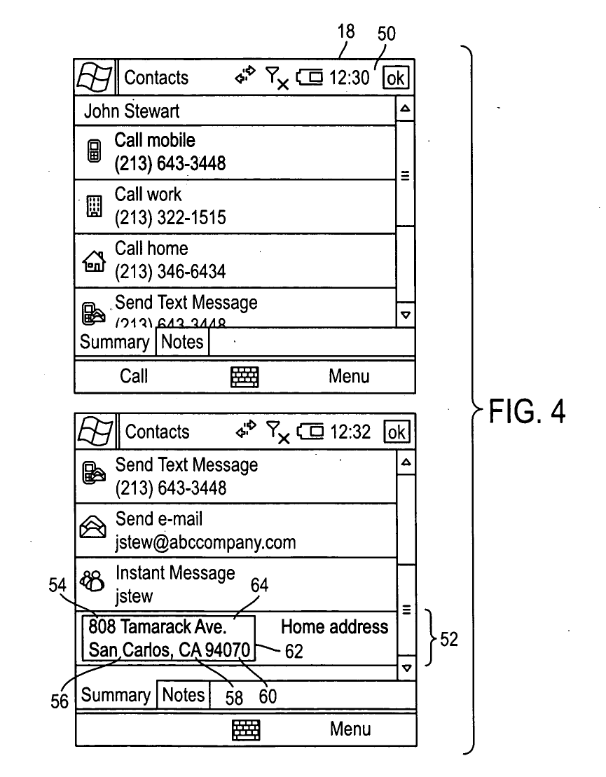

As shown in FIGS. 1 and 2, device 10 includes a housing 12 and a front side 14 and a back side 16. Device 10 further comprises a display 18 and a user input device 20 (e.g., a QWERTY keyboard, buttons, touch screen, speech recognition engine, etc.). Display 18 can comprise a touch screen display in order to provide user input to a processor 40 (see FIG. 3) to control functions, such as to select options displayed on display 18, enter text input to device 10, or enter other types of input. Display 18 also provides images (see, e.g., FIG. 4) that are displayed to and may be viewed by users of device 10. User input device 20 can provide similar inputs as those of touch screen display 18. Device 10 can further comprise a stylus 24 to assist the user in making selections on display 18.

Referring now to FIG. 3, device 10 comprises a processing circuit 46 comprising a processor 40. Processor 40 can comprise one or more microprocessors, microcontrollers, and other analog and/or digital circuit components configured to perform the functions described herein. Processor 40 comprises one or more memory chips (e.g., random access memory, read only memory, flash, etc.) configured to store software applications provided during manufacture or subsequent to manufacture by the user or by a distributor of device 10. In one embodiment, processor 40 can comprise a first applications microprocessor configured to run a variety of personal information management applications, such as calendar, contacts, etc., and a second, radio processor on a separate chip or as part of a dual-core chip with the application processor. The radio processor is configured to operate telephony functionality. Device 10 can be configured for cellular radio telephone communication, such as Code Division Multiple Access (CDMA), Global System for Mobile Communications (GSM), Third Generation (3G) systems such as Wide-Band CDMA (WCDMA), or other cellular radio telephone technologies. Device 10 can further be configured for data communication functionality, for example, via GSM with General Packet Radio Service (GPRS) systems (GSM/GPRS), CDMA/1XRTT systems, Enhanced Data Rates for Global Evolution (EDGE) systems, Evolution Data Only or Evolution Data Optimized (EV-DO), and/or other data communication technologies.

Device 10 comprises a receiver 30 which comprises analog and/or digital electrical components configured to receive and transmit wireless signals via antenna 22 to provide cellular telephone and/or data communications with a fixed wireless access point, such as a cellular telephone tower, in conjunction with a network carrier, such as, Verizon Wireless, Sprint, etc. Device 10 can further comprise circuitry to provide communication over a local area network, such as Ethernet or according to an IEEE 802.11x standard or a personal area network, such as a Bluetooth or infrared communication technology.

Device 10 further comprises a microphone 26 configured to receive audio signals, such as voice signals, from a user or other person in the vicinity of device 10, typically by way of spoken words. Alternatively or in addition, processor 40 can further be configured to provide video conferencing capabilities by displaying on display 18 video from a remote participant to a video conference, by providing a video camera on device 10 for providing images to the remote participant, by providing text messaging, two-way audio streaming in full- and/or half-duplex mode, etc. Device 20 also includes a loudspeaker 28, which may be used to provide audible output to users in addition to, or instead of, various other types of output.

Device 10 further comprises a location determining application, shown in FIG. 3 as GPS application 44. GPS application 44 can communicate with and provide the location of device 10 at any given time. Device 10 may employ one or more location determination techniques including, for example, Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), and so forth.

Device 10 may be arranged to operate in one or more location determination modes including, for example, a standalone mode, a mobile station (MS) assisted mode, and/or an MS-based mode. In a standalone mode, such as a standalone GPS mode, device 10 may be arranged to autonomously determine its location without real-time network interaction or support. When operating in an MS-assisted mode or an MS-based mode, however, device 10 may be arranged to communicate over a radio access network (e.g., UMTS radio access network) with a location determination entity such as a location proxy server (LPS) and/or a mobile positioning center (MPC).

Device 10 may further comprise a location information database 42. Database 42 includes information for various locations (e.g., streets, intersections, restaurants, hotels, banks, etc.), including location names, addresses, phone numbers, etc., and may contain additional location-specific information (e.g., hours of operation, menus, point-of-interest information, etc.). As discussed in more detail below, processor 40 can access the information stored in database 42 and can provide location-based data that may include a map, driving directions, point of interest information (e.g., location, hours of operation, menus, reviews, etc.), etc. The location-based data may be provided in response to a request initiated by a user. The request may comprise a user selecting a link (an icon, an embedded function/application call, etc.) that is associated with an address. Upon receiving the request, processor 40 provides one or more types of location-based data for the address. Various embodiments of providing location-based data are discussed in more detail below.

Referring to FIGS. 4-11, processor 40 is configured to recognize or identify addresses or address-related information (e.g., a name associated with an address) within text (e.g., text strings) that may be embedded within a variety of formats (e.g., a data field for a contacts application, an email, a text message, a word processing document, a web page, etc.). Text can be received wirelessly from a remote device (e.g., during a synch operation), loaded from an on-board memory or memory card, or received as user input. Processor 40 provides a selectable or activatable link (e.g., an icon, a selectable portion of text, an embedded function/application call, etc.) associated with the address (or address-related information), that permits users to initiate a request for location-based data by selecting the link. Upon receiving a selection of the link, or a subsequent link provided by clicking (e.g., right-clicking or left-clicking) the link, processor 40 generates and provides location-based data in one or more formats (as discussed in more detail with respect to FIGS. 8-10). The location-based data is provided based upon the address associated with the link and, in one exemplary embodiment, the current location of device 10 (e.g., the location-based data may or may not be a function of the location of device 10).

Referring now to FIG. 4, according to one embodiment, processor 40 is configured to provide a selectable link for one or more fields associated with a contact stored by contacts application 48. As shown in FIG. 4, contacts application 48 is configured to store and permit access to various types of contact information regarding individuals, entities, etc. For example, for each contact, contacts application 48 may permit a user of device 10 to store, among other information, a name, a phone number (home, work, etc.), an e-mail address, a street address, etc. Contacts application 48 permits a user of device 10 to view the contact information, either for multiple contacts at a time, or for a single contact.

Referring to FIG. 4, an image 50 containing contact information for a single contact is shown. Image 50 includes an address field 52. Image 50 may optionally further include additional fields such as a phone field, a text message field, an email field, an instant message field, etc. As shown in FIG. 4, field 52 includes an address 64 comprising a street address 54, a city 56, a state 58, and a zip code 60. According to various alternative embodiments, address 64 may include more or less information than that shown in FIG. 4. For example, address 64 may include only a city and/or state, or may include a country in addition to or instead of other information, etc. For the purposes of this disclosure, the various possible combinations of one or more of a street address, city, state, zip code, country, etc. are herein referred to as an “address” (e.g., such that a city name such as “New York” may be an address), unless otherwise specified. Other data stored with the address, e.g., a name, phone number, etc., is associated with the address by contacts application 48. Link 62 may be a hypertext link, a hot link, etc.

According to one embodiment, field 52 comprises a link 62 (e.g., an icon, a selectable portion of text, an embedded application/function call, etc.) which may or may not be visible to the user that is associated with the information in address field 52 and the particular contact. Link 62 is selectable by a user (e.g., by highlighting, clicking on, touching with stylus 24, etc.). As shown in FIG. 4, link 62 may comprise the text of address 64. According to an alternate embodiment, link 62 may include a selectable icon displayed in or near address field 52. Selection of link 62 by a user initiates a request for location-based data.

As shown in FIG. 4, link 62 is provided in address field 52. According to various alternative embodiments, link 62 may be provided as a part of one or more of the other fields associated with a particular contact. According to one embodiment, a user may select any data field for a given contact in order to initiate the request for location-based data. According to another embodiment, a user may be provided with a menu of options upon selecting link 62, for example, prompting a user to indicate whether to provide location-based data for the contact or to automatically place a phone call to the contact.

According to an alternative embodiment, processor 40 is configured to recognize or identify addresses that are embedded within text that may be provided in a variety of formats, including emails, text messages, word processing documents, web pages, etc. Processor 40 compares text to be displayed on device 10 with the contents of contacts application 48 or other application or record or file accessible by an application storing similar information (e.g., addresses, etc.). If processor 40 recognizes a portion of the text as being the same as the information stored in a data field for contacts application 48, processor 40 provides a selectable link when displaying the text such that a user may initiate a request for location-based data by selecting the link.

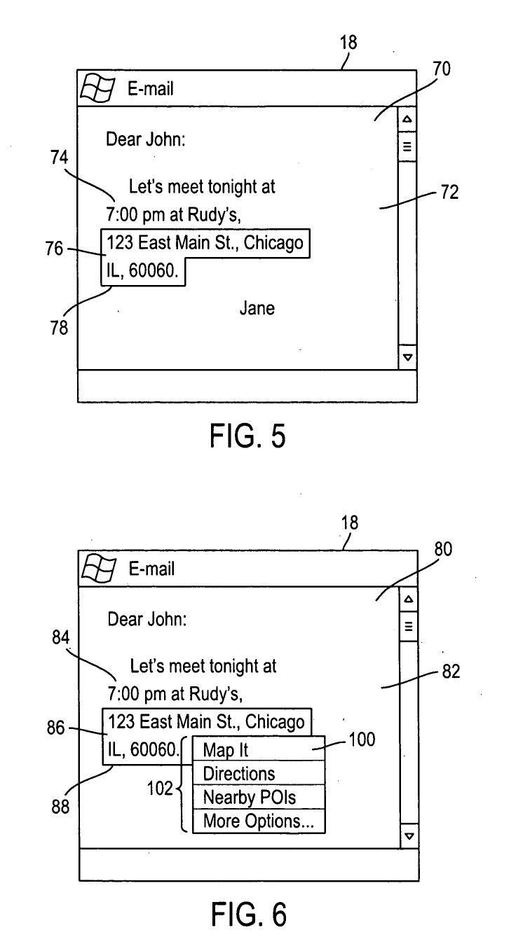

Referring to FIG. 5, an image 70 of an email message 72 is shown. Message 72 includes text 74 having address data 76. Processor 40 compares text 74 to the information stored by contacts application 48 (e.g., information such as that illustrated in FIG. 4), and provides a selectable link, shown as link 78 in FIG. 5, upon recognizing matching information. As shown in FIG. 5, processor 40 has recognized an address. According to an alternative embodiment, processor 40 recognizes other address-related information (e.g., other data related to a particular address stored by contacts application 48). For example, if a name appears in a text string, and the name is associated with an address stored by contacts application 48, processor 40 provides a selectable link for the name, with the link being associated with both the name and the address.

Referring to FIG. 6, according to another alternative embodiment, processor 40 utilizes a parsing algorithm to parse text and identify addresses within the text. According to one embodiment, the algorithm may be based on recognizing certain strings of characters, for example, a street address, followed by a comma, followed by a city, followed by a comma, followed by a state, etc. Other known algorithms for parsing text may alternatively be used. After identifying an address, processor 40 provides a link when displaying the text such that a user may initiate a request for location-based data based upon the address (e.g., by selecting a link associated with the address). For example, referring to FIG. 6, an image 80 similar to image 70 of FIG. 5 is provided, except that link 88 in FIG. 6 is provided in response to processor 40 applying a parsing algorithm to text 84 illustrated in FIG. 6 to identify address 86 (rather than comparing text 84 to the information stored by contacts application 48, as described with respect to FIG. 5). Link 88 initiates a request for location-based data when selected by a user.

Referring to both FIGS. 5 and 6, text comparisons and parsing algorithms are dependent upon the data being analyzed, and whether a portion of text is actually an address may at times remain ambiguous to processor 40 (e.g., as a result of informal or abbreviated address formats). In such a case, processor 40 may highlight or otherwise identify a potential address and provide a user with the ability to specify whether the identified text in fact is an address. For example, if a potential match between a portion of text and information from a contact data field is identified, processor 40 may provide the information from the contact data field in, for example, a pop-up menu and permit the user to verify that processor 40 should provide a link associated with the contact. Other means of permitting a user to confirm whether a potential address identified by processor 40 matches certain contact information may alternatively be used. According to one embodiment, if processor 40 does not identify an address (e.g., through either a comparison with a contacts application or through a text-parsing algorithm), the user may also manually select address data within text and manually create a link to request location-based data associated with the address data.

Referring to FIGS. 4-6, a user is provided with a selectable link that is associated with an address. According to one embodiment, the link may comprise the text of an address that is displayed in a different manner than other portions of text (if any) displayed with the address. For example, the address may be displayed in a different font type/color/size, may be underlined, italicized, etc., may be shaded, highlighted, etc., and so on. Further, a selectable icon (e.g., a balloon, pointer, etc.) may be provided as a link adjacent to the address. Processor 40 permits users to initiate a request for location based data by selecting the link.

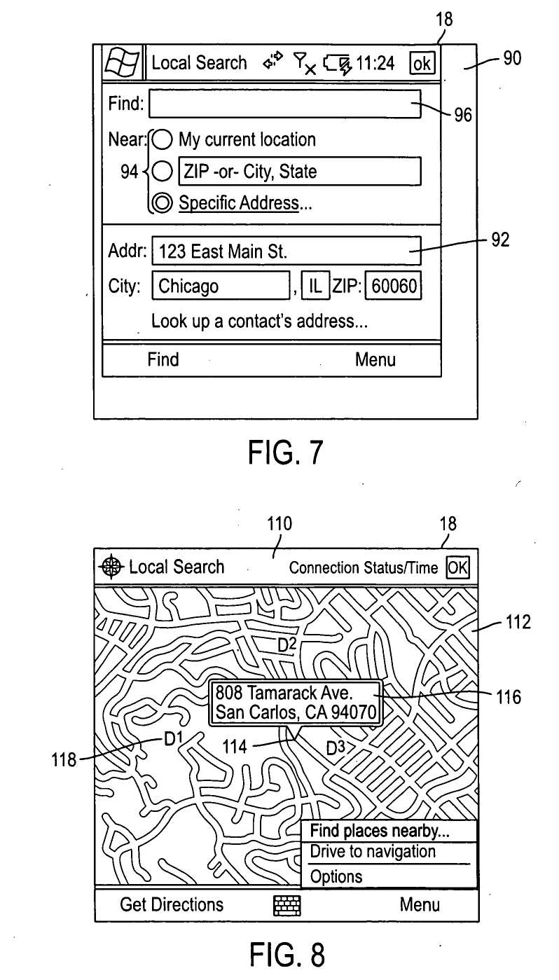

According to one embodiment, upon a user initiating a request for location-based data, processor 40 launches a location-based data application, as shown in FIG. 7. As shown in FIG. 7, processor 40 provides an image 90 for the location-based data application that includes user input fields 92, 96 that, according to one embodiment, are configured to receive text input from a user. Processor 40 uses the text to provide location-based data to the user. According to one embodiment, as a result of a user selecting a link such as link 88 shown in FIG. 6, image 90 is displayed with one or more of user input fields 92, 96 automatically populated with the address data or other information associated with the link. A user may then perform a location-based search without the need to manually enter any additional data into the location-based data application.

According to an alternative embodiment, initiating a request for location-based data results in processor 40 providing a menu of options to a user. For example, referring back to FIG. 6, a menu 100 of options 102 may be provided, including the options to map the location of the address, get driving directions to and/or from the address, identify nearby points of interest, or other options (e.g., adding an address to a contacts database, placing a phone call to a phone number associated with the address, etc.).

Once the location-based search is initiated, processor 40 utilizes the address associated with the selected link to search location information database 42 for location-based data satisfying the search parameters. According to various alternative embodiments, the location-based data may be based not only on an address, but on the current location of device 10. Processor 40 may communicate with GPS application 44 (or other location-determining application), which may be “on board” or integral with device 10, or which may be nearby and communicating with device 10 over a personal area network (e.g., via Bluetooth, infrared, etc.), to determine the current location of device 10. According to one embodiment, if GPS application 44 is unable to determine the current location of device 10, processor 40 may prompt a user to manually input the current location (e.g., latitude, longitude, etc., or an address to be correlated with a latitude/longitude using a geographic information database), or may provide a list of default locations from which a user may select.

According to one embodiment, processor 40 generates the location-based data in conjunction with location information database 42, both of which are located on device 10 in an on-board configuration as shown in FIG. 3. According to an alternative embodiment, processor 40 may wirelessly transmit the information for the location-based search to an off-board remote (e.g., physically detached) server that generates and wirelessly transmits the location-based data back to processor 40. According to another embodiment, processor 40 and location information database 42 may both be located on-board device 10, but processor 40 may periodically query an off-board remote server to update the information in location database 42, in a hybrid configuration.

Referring to FIGS. 8-10, various types of, and formats for, location-based data that may be provided by processor 40 are illustrated. For example, as shown in FIG. 8, processor 40 may provide an image 110 that includes a geographic map 112. Map 112 may indicate the location 114 of an address 116. Address 116 may be an address that is associated with a selectable link such as that described in the various embodiments discussed herein. Map 112 may also indicate the location(s) of one or more points of interest 118. According to one embodiment, a user may select (e.g., point to, click-on, hover over, etc.) a point of interest and be provided with additional information, such as an address, phone number, hours of operation, etc.

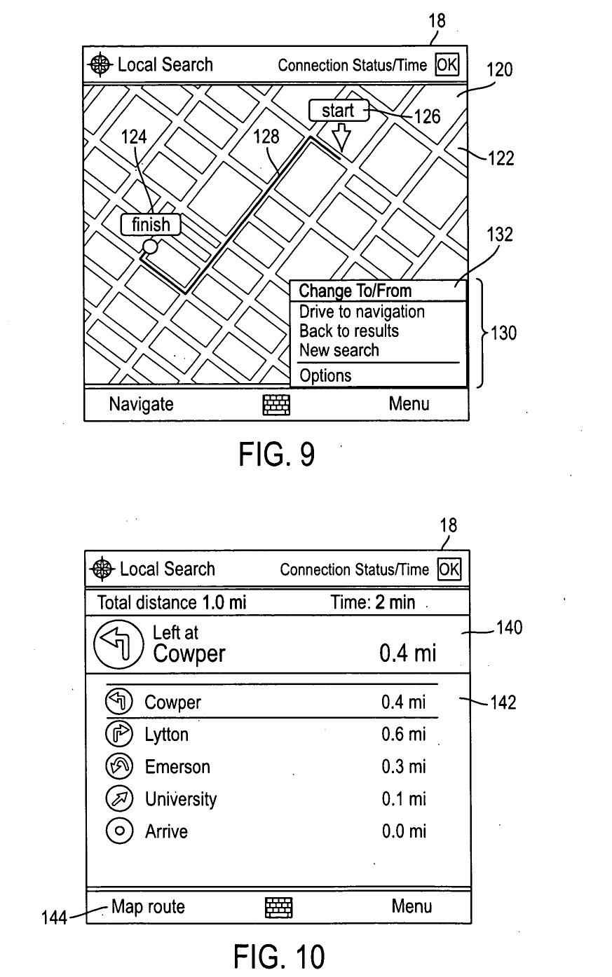

Referring to FIG. 9, processor 40 may provide an image 120 that includes a map 122 having driving directions (e.g., a route, etc.) 128 from a start point 126 to a finish point 124. Image 120 may also provide a menu 132 of options 130 (e.g., change to/from, drive to, new search, etc.) that are linked to a location-based data application such as that discussed with respect to FIG. 7. Image 120 may further include point of interest information, for example, along route 128 that provides a user with locations for nearby hotels, restaurants, ATM's, etc.

As shown in FIGS. 8 and 9, processor 40 provides the location-based data in a graphical format superimposed upon a map. According to various alternative embodiments, the location-based data may be provide in various other formats (e.g., in a textual image, audibly via loudspeaker 28 on device 10, etc.). For example, referring to FIG. 10, processor 40 provides an image 140 having driving directions 142 in a text format. According to one embodiment, one or more images provided by processor 40 may include a toggle button, such as toggle button 144 shown in FIG. 10, which permits a user to toggle between, for example, a graphical image of the location-based data and a textual display of location-based data. According to another alternative embodiment, initiating a request for location-based data (e.g., by selecting a link such as link shown in FIG. 6) may result in a user being directed to one of the images shown in FIGS. 8-10 without needing to make any further selections from menus, etc.

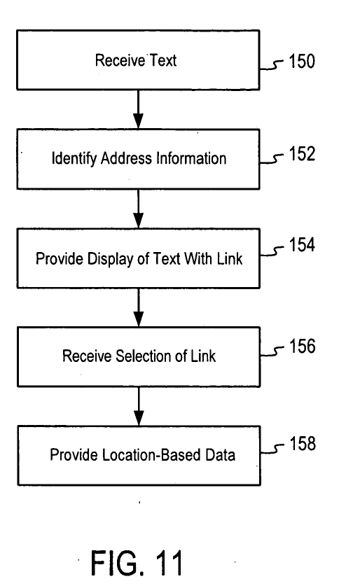

Referring now to FIG. 11, a flow chart is shown that illustrates the process of providing location-based data based on a request initiated by a selectable link. At step 150, processor 40 receives text to be displayed on display 18. The text may be part of an email, a text message, a word processing document, a web page, etc. At step 152, processor 40 identifies an address (or address-related information) using one of the methods described herein or any other suitable method. At step 154, upon identifying the address, processor 40 displays the text with a selectable link associated with the address. The link may comprise the address or may be any other selectable link, icon, etc. At step 156, processor 40 receives a selection of the link and a request for location-based data is initiated. At step 158, in response to the request for location-based data, processor 40 generates the location-based data and provides the location based data to a user, for example, in one or more of the formats illustrated herein.

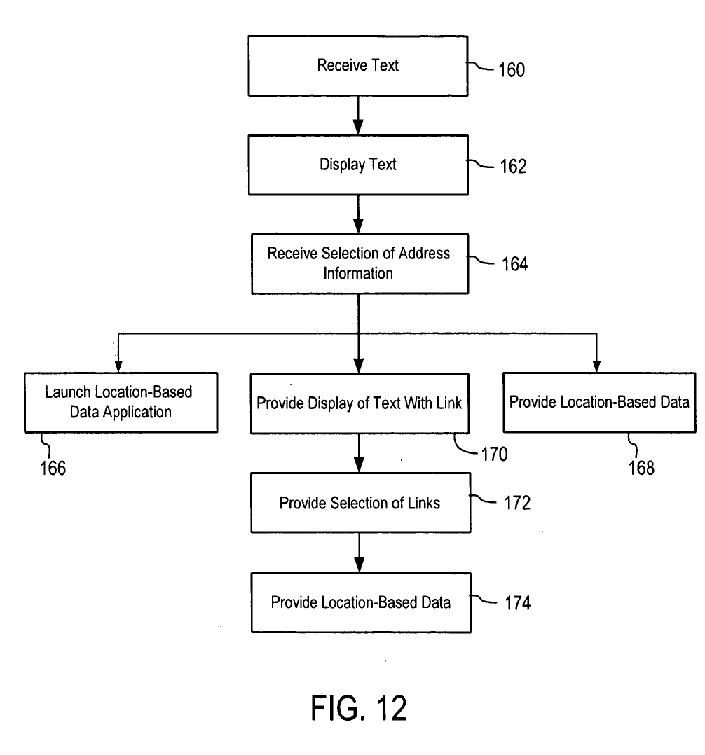

As discussed with respect to FIGS. 4-6 and 11, processor 40 recognizes or identifies an address with text for which to provide a selectable link. According to an alternative embodiment, processor 40 permits a user to manually select or identify (e.g., by highlighting) addresses within text. Processor 40 may then provide a link for the selected text and/or provide location-based data based upon the address identified by the user. A flowchart illustrating the process is shown in FIG. 12. At step 160, processor 40 displays text via display 18. As discussed with respect to FIG. 11, the text may be part of an email, a text message, a word processing document, a web page, etc. At step 162, processor 40 receives an identification of an address or address-related information from a user (e.g., by the user highlighting or otherwise identifying a portion of text). At step 164, processor 166 initiates a location-based search based upon the address. At steps 166, 168, 170, processor 40 may perform one or more actions, including launching a location-based data application with user input fields automatically populated (step 166), providing location-based data in a graphic, textual, or other format (step 168), or displaying the text with a selectable link such that a user may select the link at a subsequent time (step 170). Upon receiving a selection of the link at a subsequent time (step 172), processor 40 then provides the location-based data associated with the link (step 174).

While the detailed drawings, specific examples and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A method of providing a selectable link associated with an address, comprising:
providing text to be displayed on a display of an electronic device;
identifying address data within the text, the address data being associated with an address; and
providing the text on the display with a selectable link associated with the address.

2. The method of claim 1, further comprising receiving the text in at least one of an email, a text message, a word processing document, a web page, and a contact data field.

3. The method of claim 1, wherein identifying the address data comprises determining that the address data is being displayed within a data field of a contacts application.

4. The method of claim 1, wherein identifying the address data comprises comparing the text to the contents of a data field of a contacts application.

5. The method of claim 1, wherein identifying the address data comprises applying a text-parsing algorithm to the text.

6. The method of claim 1, wherein the selectable link comprises at least a portion of the address data.

7. The method of claim 6, wherein the portion of the address data differs from a remainder of the text in at least one of a text font type and a text color.

8. The method of claim 1, further comprising:
receiving a selection of the selectable link; and
providing location-based data in response to receiving the selection, the location-based data based upon the address.

9. The method of claim 8, further comprising:
determining the location of the electronic device;
wherein the location-based data is further based upon the location of the electronic device.

10. The method of claim 10, wherein the address data is a name associated with the address.

11. The method of claim 1, wherein providing the location-based data comprises providing at least one of the geographic location of the address, at least one point of interest located near the address, and driving directions to and/or from the address.

12. The method of claim 1, wherein the electronic device is a handheld computing device.

13. An electronic device, comprising:
a processor; and
a display;
wherein the processor is configured to
provide text to be displayed on the display;
identify address data within the text, the address data associated with an address; and
provide the text on the display with a selectable link associated with the address.

14. The electronic device of claim 13, wherein the processor is configured to identify the address data by determining that the address data is being displayed as a part of a data field for a contacts application.

15. The electronic device of claim 13, wherein the processor is configured to identify the address data by comparing the text to the contents of a data field for a contacts application.

16. The electronic device of claim 13, wherein the processor is configured to identify the address data by applying a text-parsing algorithm to the text.

17. A method of providing location-based data, comprising:
providing text on a display for an electronic device;
receiving a selection of at least a portion of the text from a user; and
launching an application configured to provide location-based data in response to receiving the selection from the user.

18. The method of claim 17, wherein the text is included in one of an email, a text message, a word processing document, and a web page.

19. The method of claim 17, wherein launching the application comprises providing an image containing at least one user input field populated with the selected portion of text.

20. The method of claim 17, further comprising providing location-based data based upon the selected portion of text.
